(19) United States
(12) Patent Application Publication
(10) Pub. No.: US 2024/0261697 A1
(43) Pub. Date: Aug. 8, 2024

(54) LIGHT-EMITTING FLYING DISC

(71) Applicant: Shenzhen Shuocai optoelectronic Technology Co., LTD., Shenzhen (CN)

(72) Inventor: Hong CHEN, Shenzhen (CN)

(73) Assignee: Shenzhen Shuocai optoelectronic Technology Co., LTD., Shenzhen (CN)

(21) Appl. No.: 18/410,927

(22) Filed: Jan. 11, 2024

(30) Foreign Application Priority Data
Feb. 3, 2023 (CN) 202320104075.9

(51) Int. Cl. A63H 33/18; F21L 4/02; F21L 4/08; F21V 23/00; F21V 23/04; F21V 31/00; F21V 33/00; F21Y 103/10; F21Y 103/33; F21Y 115/10

(52) U.S. Cl. CPC A63H 33/18; F21L 4/027; F21L 4/08; F21V 23/006; F21V 23/0414; F21V 31/005; F21V 33/008; F21Y 2103/10; F21Y 2103/33; F21Y 2115/10

(57) ABSTRACT

The present utility model relates to the technical field of flying discs, particularly to a light-emitting flying disc, including a disc body. A mounting slot is provided at the center of the bottom of the disc body, a light strip slot is provided at the periphery of the mounting slot, a power supply assembly is mounted in the mounting slot, an LED light strip is mounted in the light strip slot, the LED light strip is electrically connected to the power supply assembly, and a bottom cover for covering the mounting slot and the light strip slot is further mounted at the bottom of the disc bottom. By mounting a light strip at the bottom of the flying disc, the present utility model enables the flying disc to be used in a place where the field of view is unclear to expand the use scene of the flying disc.

### CROSS-REFERENCE TO RELATED APPLICATIONS

The application claims priority to Chinese patent application No. 202320104075.9, filed on Feb. 3, 2023, the entire contents of which are incorporated herein by reference.

### TECHNICAL FIELD

The present utility model relates to the technical field of flying discs, in particular to light-emitting flying discs.

### BACKGROUND

Playing flying discs is a kind of fitness event that is suitable for the old and the young. As long as there is open grassland, the exercise can be carried out. The throwing and receiving methods are so diverse that flying discs have attracted a lot of outdoor sports enthusiasts. A flying disc is mainly a kind of throwing disc device, and common flying discs can only be used in the daytime or a place with bright light. In order to facilitate the flying disc sports enthusiasts in playing the flying disc in places with unclear views, modifications have been made to flying discs.

Therefore, a flying disc equipped with an LED lamp appears on the market. When a flying disc is used in a place with an unclear field of view, the LED lamp on the flying disc can be turned on, so that the flying disc can emit light, and the position of the flying disc can be seen when the flying disc is used. However, the position where the LED lamp is mounted in the flying disc is relatively thick, and the middle position of the flying disc is used for mounting a power generation element, which occupies a relatively large space. The power generation elements are distributed and mounted in the middle of the flying disc, and are covered with a cover plate after the mounting is completed. After the mounting is completed, since the power generation element is relatively thick, the thickness of the middle position of the flying disc changes significantly compared with a general flying disc. Compared with flying discs with the same diameter, the increase in the numerical value of the thickness of the flying disc is larger, which will affect the user's use effect. Itis difficult for the existing light-emitting flying discs on the market to solve the problem of changing the thickness of the flying disc to a smaller extent and mitigating the influence on the using effect to a smaller extent while emitting light.

### SUMMARY

In order to solve the problems of the prior art, the present utility model provides a light-emitting flying disc. The middle position at the bottom of the flying disc is provided with a mounting slot position, a light strip is mounted around the mounting slot, and the space and thickness of the flying disc increased by the mounting slot are small, which has little effect on the mass and thickness of the flying disc. The flying disc can be conveniently used in a place with an unclear field of view, so as to reduce the limited range of the use of the flying disc. Under this condition, the effect of other factors on the use of the flying disc is reduced.

The solutions adopted by the present utility model to solve its technical problems are as follows: a light-emitting flying disc is disclosed, including a disc body, wherein: a mounting slot is provided at the center of the bottom of the disc body, a light strip slot is provided on a periphery of the mounting slot, a power supply assembly is mounted in the mounting slot, an LED light strip is mounted in the light strip slot, the LED light strip is electrically connected to the power supply assembly, and a bottom cover for covering the mounting slot and the light strip slot is also mounted at the bottom of the disc bottom.

By adopting the above-mentioned technical solution, a light strip is mounted in a mounting slot provided at the bottom of the disc body, the light strip can be controlled by a control switch, and the flying disc can emit light through the light strip when it is used in a place with an unclear field of view, so that a user can also use the flying disc in a place with an unclear field of view.

Further, an edge of the disc body forms a flying disc edge portion along the bottom of the disc body, a cavity is formed between the flying disc edge portion and the bottom of the disc body, and the light strip slot is located on one side of the bottom of the disc body facing the cavity.

By adopting the above-mentioned technical solution, the light strip can be located in a cavity after being mounted such that the impact on the light strip when the flying disc falls off during use can be reduced, and thus the service life of the light strip can be extended.

Further, the mounting slot is provided at the bottom of the disc body, the diameter of the mounting slot is less than the diameter of the flying disc, a fixing slot for mounting the bottom cover is provided at the periphery of the light strip slot, the bottom cover is fitted into the fixing slot, a sealing ring is provided in the fixing slot, and the bottom cover is fitted with the sealing ring.

By adopting the above-mentioned technical solution, the fixed mounting of the bottom cover is realized, and the fixing slot is arranged at the periphery of the light strip slot, so that the bottom cover can cover the light strip slot and the mounting slot after being mounted, thereby realizing the protection of the light strip and the power supply assembly. The arrangement of the sealing ring makes the mounting of the bottom cover more stable.

Further, the power supply assembly comprises a battery for supplying power to a light strip and a circuit board for transmitting electricity, the light strip is connected to the circuit board, and the circuit board is provided with a charging port for charging and a switch button and an adjustment button for controlling the light strip.

By adopting the above-mentioned technical solution, a charging port is provided on the circuit board, and it is charged into the battery through the charging port for storage, so that the flying disc directly uses the battery to supply power to the light strip when it is used, which is more convenient to use; and the switch of the light strip is controlled by the switch button, the light strip is turned on when it is needed to be used so as to avoid waste, and the button is adjusted for controlling the light of the light strip.

Further, a closure assembly is mounted on the bottom cover, and the closure assembly is provided with a charging slot and a button cover.

By adopting the above-mentioned technical solution, a closure assembly is mounted on the bottom cover, and the charging port and the button position in the mounting slot are mounted in the closure assembly via the bottom cover, so that it can facilitate charging during use, and it can have a certain protection function for the charging port and the switch button.

Further, the bottom cover is provided with a closure slot for mounting a closure assembly, and the closure assembly is mounted on the outer surface of the bottom cover.

By adopting the above-mentioned technical solution, the closure assembly is mounted on the outer surface of the bottom cover, so as to facilitate the use of the charging port and the switch button. The closure assembly is mounted so as to protect the charging port and the switch button so as to avoid the entry of sundries during use such that it can prevent certain external conditions from affecting the use of the light strip.

Further, the circuit board is provided with a mounting hole, the bottom cover is provided with a protrusion corresponding to the mounting hole, and the protrusion is fitted with the mounting hole.

By adopting the above-mentioned technical solution, a mounting hole is provided at the circuit board position, a protrusion on the bottom cover is fitted with the mounting hole, and the bottom cover is fixed on the flying disc by the mounting between the two, so that no falling-off phenomenon occurs during use.

Compared with the prior art, the beneficial effects of the present utility model are as follows. A light strip is mounted in the flying disc, and the space required for mounting the light strip is small, so that the use effect of the flying disc is not affected, and a user can also use the flying disc when it is relatively dark. After mounting the light strip, the flying disc is more beautiful. Compared with the prior art, a mounting slot is provided in the flying disc, and the light strip is mounted in the mounting slot. Under the premise of ensuring the use effect, the use effect of the flying disc in a place with an unclear field of view can be achieved.

The above description is only an overview of the technical schemes of the invention. In order to understand the technical means of the invention more clearly, it can be implemented according to the contents of the description. In order to make the above and other purposes, features, and advantages of the invention more obvious and understandable, the following are specific preferred embodiments, accompanied by accompanying drawings, for detailed explanation.

### BRIEF DESCRIPTION OF DRAWINGS

FIG. 1 is a schematic diagram of the structure of a flying disc in the present embodiment;

FIG. 2 is an exploded schematic diagram of the present embodiment;

FIG. 3 is a schematic diagram of a cross-sectional structure of the present embodiment:

FIG. 4 is an enlarged view at A in FIG. 3; and

FIG. 5 is a schematic diagram of the structure of a bottom cover in the present embodiment.

In the drawings: 1, a disc body; 11, a mounting slot; 12, a light strip slot; 13, a fixing slot; 2, a power supply assembly; 21, a battery; 22, a circuit board; 221, a mounting hole; 23, a switch button; 24, an adjustment button; 3, an LED light strip; 4, a bottom cover; 41, a closure slot; 42, a protrusion; 5, a flying disc edge portion; 51, a cavity; 6, a sealing ring; 7, a capping assembly; 71, a charging slot; and 72, a button cover.

### DETAILED DESCRIPTION OF THE EMBODIMENTS

In order to make the content of the present utility model easier to understand, the following will further explain the present utility model based on specific embodiments and in conjunction with the accompanying drawings.

It needs to be noted that the orientation or positional relationships indicated by the terms used herein “center”, “up”, “down”, “front”, “back”, “left”, “right”, “top”, “inside”, “outside” etc. are based on the orientation or positional relationship shown in the drawings, and are only for the convenience of describing the utility model and simplifying the description, rather than indicating or implying that the referred device or element must have a specific orientation, or be constructed and operated in a specific orientation, and therefore cannot be construed as a limitation of the present utility model. Unless otherwise stated, the term “multiple” means two or more.

Unless otherwise expressly specified and limited, the terms “mounted” “connected”, and “connecting” should be interpreted broadly. For example, it can be a fixed connection or a detachable connection, or an integrated connection, it can be a mechanical connection, or an electrical connection; it can be directly connected or indirectly connected through an intermediate medium, and it can be the communication within two elements. For a person of ordinary skills in the art, the specific meaning of the above-mentioned terms in the present utility model can be understood according to specific situations.

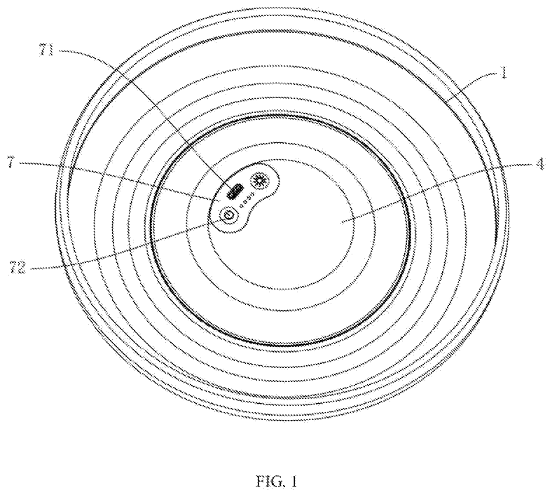

As shown in FIGS. 1 to 3, a light-emitting flying disc includes a disc body 1; a mounting slot 11 is provided in the circular middle portion of the disc body 1 in the present embodiment, and the diameter of the mounting slot 11 is smaller than the diameter of the disc body 1; an annular light strip slot 12 is provided around the mounting slot 11, the light strip slot 12 is used for mounting a light strip, the light strip is mounted around the light strip slot 12, and the position of the mounting slot 11 for mounting the light strip is narrow; and compared with a common flying disc with the same diameter and the same material, the use effect of the flying disc after the addition of the light strip is not very different, without affecting the experience effect of a user. In addition, the flying disc can also be used where the field of view is unclear under the condition that the use effect is ensured, and a bottom cover 4 is also mounted at the position of the mounting slot 11, and the bottom cover 4 in the present embodiment can cover the mounting slot 11 and the light strip slot 12 on which the light strip is mounted, so as to achieve a sealing function.

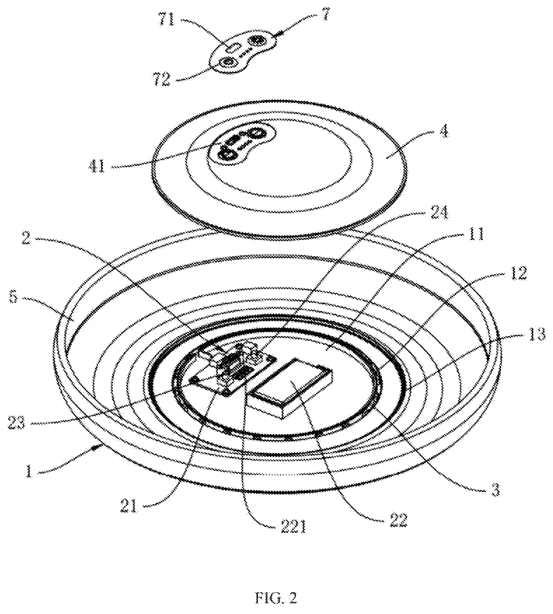

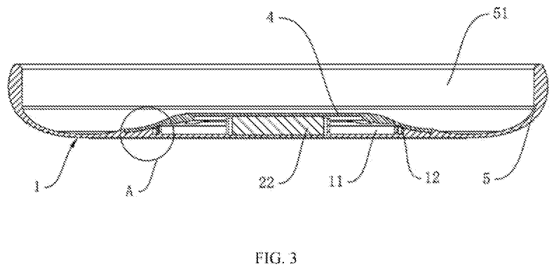

As shown in FIGS. 2 and 3, the edge of the disc body 1 of the present embodiment is bent along the bottom of the disc body 1 to form a flying disc edge portion 5, a cavity 51 is formed between the flying disc edge portion 5 and the bottom of the disc body 1, and the light strip slot 12 and the mounting slot 11 are both located on one side of the bottom of the disc body 1 facing the cavity 51. Therefore, when the flying disc falls to the ground during use, the flying disc edge portion 5 can perform supporting such that the bottom of the disc body 1 is away from the ground, thereby reducing the influence that the light strip and the power supply assembly 2 are subjected to, and extending the service life of the light strip and the power supply assembly 2, and thereby extending the service life of the flying disc.

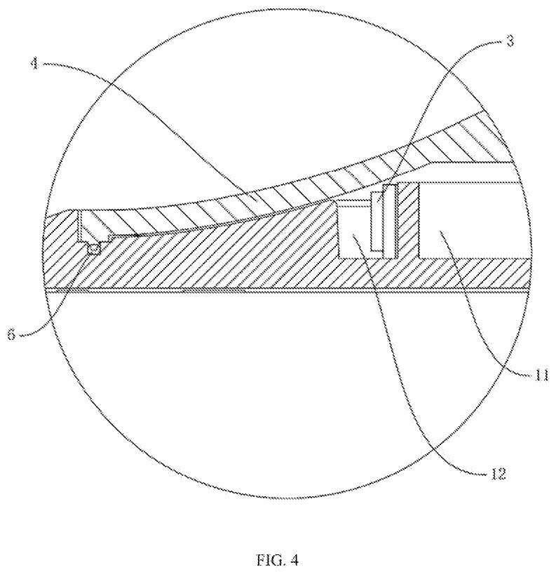

As shown in FIG. 2, in the present embodiment, a battery 21 and a circuit board 22 are mounted in the mounting slot 11, the light strip is connected to the circuit board 22, and the battery 21 and the circuit board 22 are connected. The circuit board 22 is further provided with a charging port and a switch button 23. The switch button 23 can turn on the light strip so that the light strip emits light, and the adjustment button 24 is used for controlling the brightness and color of the light strip; a fixing slot 13 is further provided around the light strip slot 12 in the present embodiment, and when the bottom cover 4 is mounted, the bottom cover 4 can be fixedly mounted on the bottom of the disc body 1 via the fixing slot 13; in addition, the diameter of the fixing slot 13 in the present embodiment is greater than the diameter of the light strip slot 12, so that after the bottom cover 4 is mounted, the light strip slot 12 and the mounting slot 11 can be covered so as to protect the LED light strip 3 and the power supply assembly 2; and as shown in FIG. 4, in order to improve the mounting firmness of the bottom cover 4, the present embodiment further provides a sealing ring 6 in the fixing slot 13, so that when the bottom cover 4 is mounted, the connecting position of the bottom cover 4 fits into the fixing slot 13 and then tightly fits with the sealing ring 6, thereby making the mounting of the bottom cover 4 firmer and improving the protection performance of the bottom cover 4.

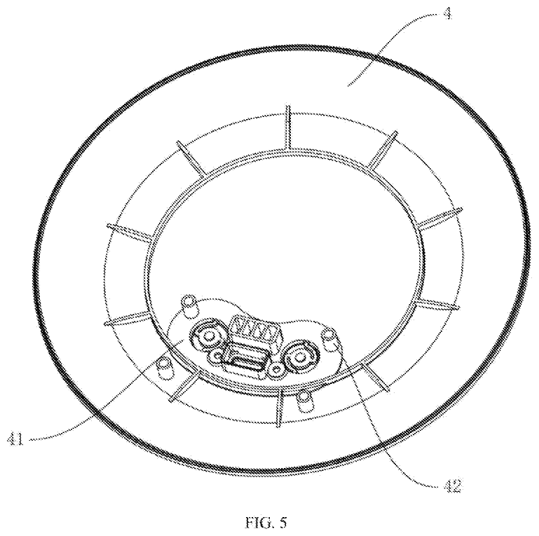

As shown in FIG. 5, in the present embodiment, a closure slot 41 is provided on the bottom cover 4, and a capping assembly 7 is mounted in the mounting slot 11; in the present embodiment, the capping assembly 7 includes a charging slot 71 and a button cover 72, wherein two button covers 72 are provided, one of which is a switch button 23 for controlling the switch of the light strip, and the other is an adjustment button 24 for adjusting the brightness and color of the light strip; the charging slot 71 is located between the switch button 23 and the adjustment button 24; in the present embodiment, the capping assembly 7 is mounted on the outer surface of the bottom cover 4, and the closure slot 41 for mounting the capping assembly 7 is provided on the bottom cover 4; the thickness of the closure slot 41 is the same as the thickness of the capping assembly 7, so that the capping assembly 7 can be completely mounted into the closure slot 41; the circuit board 22 in the closure slot 41 is provided with a mounting hole 221, and the bottom cover 4 is provided at a position corresponding to the circuit board 22 with a protrusion 42 which engages with the mounting hole 221, wherein the protrusion 42 is provided on one side of the bottom cover 4 close to the closure slot 41, and the bottom cover 4 can be fixed on the disc body 1 after being mounted, without falling off during its use; and the closure assembly is engaged on the bottom cover 4 so as to prevent the capping assembly 7 from falling off during use; and ensure that the position of the charging port does not shift, so as to ensure the use effect of the flying disc.

The working principle of the present embodiment is as follows: a mounting slot 11 is provided at the middle position at the bottom of the flying disc, a light strip for emitting light is mounted in the mounting slot 11, a battery 21 is used to supply power to the light strip, and a charging port is provided for charging work; the battery 21 can be reused; the space used by the mounting slot 11 is relatively small, so that it can ensure that a user can normally use the flying disc; the difference between the use of the flying disc and a common flying disc is not great; and the flying disc mounted with the light strip can be used in a place where the field of view is unclear, and the aesthetics of the flying disc can also be enhanced.

The above-mentioned embodiments are merely preferred embodiments of the present utility model, which cannot be used to define the scope of protection of the present utility model, and any insubstantial changes and modifications made by a person skilled in the art on the basis of the present utility model fall within the scope of protection of the present utility model.

What is claimed is:

1. A light-emitting flying disc, comprising a disc body (1), wherein: a mounting slot (11) is provided at a center of a bottom of the disc body (1), a light strip slot (12) is provided on a periphery of the mounting slot (11), a power supply assembly (2) is mounted in the mounting slot (11), an LED light strip (3) is mounted in the light strip slot (12), the LED light strip (3) is electrically connected to the power supply assembly (2), and a bottom cover (4) for covering the mounting slot (11) and the light strip slot (12) is also mounted at the bottom of the disc body.

2. The light-emitting flying disc according to claim 1, wherein: an edge of the disc body (1) forms a flying disc edge portion (5) along the bottom of the disc body (1), a cavity (51) is formed between the flying disc edge portion (5) and the bottom of the disc body (1), and the light strip slot (12) is located on one side of the bottom of the disc body (1) facing the cavity (51).

3. The light-emitting flying disc according to claim 1, wherein: the mounting slot (11) is provided at the bottom of the disc body (1), a diameter of the mounting slot (1) is less than a diameter of the flying disc, a fixing slot (13) for mounting the bottom cover (4) is provided at a periphery of the light strip slot (12), the bottom cover (4) is fitted into the fixing slot (13), a sealing ring (6) is provided in the fixing slot (13), and the bottom cover (4) is fitted with the sealing ring (6).

4. The light-emitting flying disc according to claim 1, wherein: the power supply assembly (2) comprises a battery (21) for supplying power to a light strip and a circuit board (22) for transmitting electricity, the light strip is connected to the circuit board (22), and the circuit board (22) is provided with a charging port for charging and a switch button (23) and an adjustment button (24) for controlling the light strip.

5. The light-emitting flying disc according to claim 3, wherein: a capping assembly (7) is mounted on the bottom cover (4), and the capping assembly (7) is provided with a charging slot (71) and a button cover (72).

6. The light-emitting flying disc according to claim 4, wherein: the bottom cover (4) is provided with a closure slot (41) for mounting a capping assembly (7), and the capping assembly (7) is mounted in the closure slot (41) and is located on an outer surface of the bottom cover (4).

7. The light-emitting flying disc according to claim 4, wherein: the circuit board (22) is provided with a mounting hole (221), the bottom cover (4) is provided with a protrusion (42) corresponding to the mounting hole (221), and the protrusion (42) is fitted with the mounting hole (221).
